(19) United States
(12) Patent Application Publication
(10) Pub. No.: US 2011/0189485 A1
(43) Pub. Date: Aug. 4, 2011

(54) PROCESS FOR COVERING RUBBER PARTICLES WITH A POLYMERIC FILM AND COVERED RUBBER GRANULATES OBTAINED BY THIS PROCESS

(75) Inventors: Joäo Carlos Moura Bordado, Lisboa (PT); Isabel Rute Afonso Veloso, Sousel (PT); Inês Valente Mendes Raposeiro, Linda-a-Velha (PT); Helena Isabel Vilela De Mota, Mafra (PT); Mariana Fonseca Amaro, Lisboa (PT); Marta Sofia Guilherme Silva Candeias, Santiago do Cacem (PT)

(73) Assignee: INSTITUTO SUPERIOR TECNICO, Lisboa (PT)

(21) Appl. No.: 13/056,850

(22) PCT Filed: Sep. 26, 2008
(86) PCT No.: PCT/PT2008/000037

§ 371 Date: Apr. 20, 2011

(30) Foreign Application Priority Data
Jul. 31, 2008 (PT) 104150

(51) Int. Cl. B32B 15/02; B05D 7/00; B05D 5/06; B05D 5/00

(52) U.S. Cl. 428/407; 427/222; 427/162; 427/160

(57) ABSTRACT

The invention relates to a process for covering rubber particles with a continuous functional layer of polymeric nature, characterized by the use of a rotating drum with variable speed drive allowing for a progressive reduction of the speed and a pre-blend of a setting and filmifiable reactive fluid comprising a liquid resin selected from alkyd resins, polyvinyl chloride resin, urethane alkyd resins, polyurethane-urea resins and reactive polyester resins. The invention also relates to covered granulates obtained by this process.

### FIELD OF THE INVENTION

The present invention relates to rubber granulates, in most cases from recycled rubber tires, used with success as infill material in the top layer of artificial grass football grounds.

### BACKGROUND OF THE INVENTION

There are numerous disclosures in the prior art concerning particles covered by organic and inorganic materials. However rubber particles coated with a functional layer have apparently never been disclosed.

Kuraray Co., Ltd., C.A. 98:157436t discloses beads, particles, fibres, sheets, and tubes of glass, activated carbon, silica, alumina or high molecular weight substances coated with copolymers of acrylates and carboxylic acids or amines to form selective adsorbent carriers or supports for use in selective electrodes or in column chromatography.

Sakuma et al., C.A. 111:74363c, disclose glass or polymer spheres coated with hydroxyapatite for use as a stationary phase for column chromatography.

EP-A-0266580 discloses a method for coating solid particles with a hydrophilic gel preferably agarose for various separating processes in packed columns based on adsorbent groups, e.g. ion exchanging groups, hydrophobic groups, or groups with biospecificity chemically bound to a gel. Such coating may be provided by mixing hydrophilic solid particles with a gel-forming substance above the gelling temperature in which each individual particle is coated, separated from each other, and cooled below the gelling temperature, essentially to stabilize the particles against the high pressure in e.g. HPLC applications.

Generally, all of the above mentioned coated particles are provided by coating individual particles made of the same material.

U.S. Pat. No. 4,698,317 discloses hollow microspherical glass particles having open pores, and being prepared by spray thermal decomposition of a solution, in an aqueous organic solvent, wherein the water content promotes open pore formation.

U.S. Pat. No. 2,797,201 discloses substantially spherical, hollow particles having a “thin, strong skin” being prepared by thermal treatment of droplets of a solution of a film forming material, e.g. an organic polymer such as a phenol formaldehyde resin, and optionally further containing a “blowing agent”, i.e an agent generating gas at the elevated temperature of the thermal treatment.

GB 2151601B discloses porous hollow particles of an inorganic material and a composite material comprising such particles supporting a selected substance such as a chromatographic organic gel. The porous hollow particles may be formed by coating a fugitive core material, e.g. organic resin beads or alginate spheres, with inorganic material, and then heating to remove the fugitive core material. Further, GB 2151602B discloses closely similar particles wherein a magnetic material, such as ferric oxide, nickel oxide or cobalt oxide, is incorporated in the inorganic shell of the particle.

GB-A-2196252 discloses an oral, solid, pharmaceutical dosage form comprising conventional matrix binders including starch and cellulose, or their derivatives, and a pharmaceutically acceptable weighting agent, including inorganic compounds such as salts, oxides, or hydroxides of a metal, e.g. barium sulphate or ferrous oxide, suitable for oral administration to humans and for controlled release of a pharmaceutically active ingredient into the stomach. Furthermore, the described pharmaceutical dosage form consists of solid particles comprising a binder and a weighting agent soluble in gastric fluid which makes the pellet or tablet disintegrate shortly after ingestion.

U.S. Pat. No. 4,142,969 discloses an oleo specific hydrophobic composition comprising an intimate mixture of expanded volcanic glass consisting of perlite, a cellulose fiber, and a water repellent sizing consisting of asphalt; and a method of sorbing oleaginous compounds e.g. in selectively removing oil from the surface of water. The constituents are incorporated into a homogeneous product by a wet process, dried in an oven until essentially all moisture has been removed, and then ground up into a fluffy low density material. Nothing is disclosed nor suggested about controlling the density of the composition by incorporation of high or low density particles.

WO 00/78852 A2 discloses a process of fine rubber aggregation with a polymeric binder. The product is in this case one aggregate and not individual particles, and the process used is completely different from the one disclosed in the present invention.

EP 1422 345 A1 discloses a process for the coating of sand granules. It does not include rubber and the process is completely different since it involves the melting of the coating mixture rather than the surface cross linking of the wet film.

U.S. Pat. No. 4,381,354 discloses a process of coating sand and the process discloses is different from the one of the present invention since one halogenated compounds are used and also a metal powder.

WO 02/097194 A1 refers to a plastic flake aggregated by a binder to form final particles, but both the material and the process are different from the one considered in the present invention.

### DETAILED DESCRIPTION OF THE INVENTION

### Introduction

Rubber granulates impart to the top layer the required resilience and “natural grass feeling” but present, so far, a number of draw back, partly overcome by the present invention.

Rubber surface in presence of ultraviolet radiation, and especially if minor concentrations of ozone are present, tend to degrade forming small particles and releasing to some extent the carbon black, including the presence of inhalable dust particles.

Attrition by the players further increase mechanical abrasion with resulting dust formation.

For many years, the composition of rubber for tires included polyaromatic oils, benzotiazol derivatives and zinc compounds that slowly leach from the granules to the soil.

Polyaromatic oils are nowadays of special concern due to the presence of carcinogenic components that can migrate through the skin in case of prolonged contact.

Despite the oil and self release character of the rubber surface, very hydrophobic polymer compositions were found the fully wet the rubber surface, with suprising valves of the recorded contact angle.

Polymeric films were first prepared on glass surfaces to correlate Barrier properties with composition for the relevant range of thickness 10 micron to 80 micron.

Covering process presents however several problems that had to be solved and the mayor one is the clear tendency of the polymeric fluid composition to act as particle binder.

Mixing speed, geometry and drying kinetics had to adjusted to allow for the production of a virtually aggregate free covered rubber granulate.

Several advantages were found in the comparative tests described in the described examples.

Covered particles are virtually dustless, flame retardant, with improved U.V. and ozone resistance, and the barrier effect of the covering layer reduces leaching of zinc and organic compounds.

### DISCLOSURE OF THE INVENTION

The present invention relates to a process of covering rubber particles with a highly adherent functional layer of polymer, and the resulted covered particles.

According to the invention this is fulfilled by providing as Raw Materials, rubber granulates and a setting reactive fluid comprising a number of ingredients:

a) A liquid resin with hydrophobic macromolecular structure that readily wets the rubber surface.
b) An oleophilic organic pigment with metal less structure.
c) A finely grinded flame retardant of the polyphosphate type or any other halogen free flame retardant.
d) A flexibilizer oleophilic oil to be used as adhesion promoter and to increase the flexibility of the film.
e) A reactive cross-linker to reticulate the layer, allowing for the control of the kinetics of surface drying and also the final surface hardness.
f) An ultra violet radiation protector of the HALS type.

The process includes a pre-blend of ingredients a) to f) in one extensive mixer, followed by mixing with the rubber granulates.

A variable speed rotating reactor with internally fixed blades is initially filled with the rubber granulate and rotation started at low speed (below 10 turns by minute). The pre-blend with adjusted viscosity and setting time is added gradually over the rubber under continuous rotation, in tree steps.

Rotating speed as well as axis angle is then adjusted step by step to minimize agglomeration of the rubber.

The inclusion of formulation of a reactive cross-linker assures reactive biding to the rubber surface which is essential to promote chemical adhesion and covalent biding essential to improvement of abrasion resistance.

The process is therefore a surface coverage film by covalent bounds to the rubber surface.

Samples taken at intervals allow for the control of residual tackiness and the reactor is discharged once the residual tackiness is no further detected.

Several liquid oligomeric resins were tested comparatively as base resin for the formulation. Compatibility, surface adhesion and abrasion resistance after film formation were the main criteria to identify the best bases resin.

The best results were obtained with:

Long oil alkyd resins
Polyvinyl chloride Plastisol
Urethane alkyd resins
Polyurethane-urea resins
Polyester resins (linear)

Several cross-linking components were tested in a range of contents between 5 p.h.r. and 15 p.h.r., and the ones identified with the best results, applying the some criteria were:

Poly functional Isocyanates
Hydrofobic Ketone dimers
Isocyanate quasi-prepolymers
Poly acryl chlorides

Barrier effect of the film was then tested on film samples of different thickness, produced on glass surface previously treated with a release agent. Significant reduction on zinc leaching and reduction of the TOC in the leached solution were obtained for thickness over 30 micron and a ten fold reduction is obtained for thickness over 50 micron.

Several additives had to be included in the formulation and the content of each one was adjusted by iterative testing.

Flame retardancy was adjusted iteratively by the addition of halogen free flame retardant of the ammonium polyphosphate type (increasing step 1p.h.r.).

Very simple tests were performed after the production of each sample. Holding a covered granule with tweezers fire was countered with a pocket lighter.

Required addition level was considered attained when, by removing the lighter flame, the flame in the granule disappears spontaneously within 5 seconds.

Montemovillonite clay was used both as opacifier and also for its synergic effect, boosting the flame retardancy.

The addition level of U.V. protection was also iteratively adjusted with 0.2 p.h.r. increments. Accelerated weathering was then performed comparatively using a static U.V. lamp and evaluating abrasion resistance after weathering.

### OBJECTS OF THE INVENTION

Therefore, the first object of the invention is a process for covering rubber particles with a continuous functional layer of polymeric nature, which use a rotating drum with variable speed drive allowing for a progressive reduction of the speed and a pre-blend of a setting and filmifiable reactive fluid comprising a liquid resin selected from alkyd resins, polyvinyl chloride resin, urethane alkyd resins, polyurethane-urea resins and reactive polyester resins.

The rubber particles to be covered have, usually, average dimensions from 0.1 mm average radius to 5 mm average radius, preferably 0.5 mm to 2.5 mm.

In a preferred embodiment of the invention the pre-blend used for coverage comprises additionally one drying component with cross linking action.

The cross linking component is preferably, selected from poly functional isocyanates, hydrophobic ketene dimmers, isocyanate quasi-prepolymers and polyacrylchlorides.

The pre-blend used for coverage comprises additionally an oleophilic organic pigment, a flame retardant, a flexibilizer oleophilic oil and an ultra violet radiation protector.

The second object of the invention is the covered rubber granulates, obtained by the above process, which comprise rubber granulates covered with a pre-blend of a setting and filmifiable reactive fluid comprising a liquid resin selected from alkyd resins, polyvinyl chloride resin, urethane alkyd resins, polyurethane-urea resins and reactive polyester resins.

The covered rubber granulates has, normally, a thickness over 30 micron, preferably over 50 micron, in order to be a very effective barrier to polyaromatic oils, zinc, and other mobile components of the rubber granulate.

In the covered rubber granulates the covering film has high adherence and similar flexibility to the rubber, improving the abrasion resistance of granulate.

The colored layer of the covered rubber granulates does not suffer significant color change under exposure to ultraviolet radiation, namely under xenon lamp radiation.

The final covered particles present improved sphericity and shape regularity due to liquid surface tension before setting and virtually dustless due to small particles and powder aggregation in the wet film.

### EXAMPLES

### Example 1

Cryogenic Rubber granulate (1000 g) with average granulometry between 0.5 mm and 2.5 mm was covered using the following reactive mixture:

| | | |
|---|---|---|
| Long oil Alkyd Resin | 55 | g |
| Oleophilic, Metalless Green pigment | 5 | g |
| Ammonium Polyphosphate (powder) | 18 | g |
| Montemovillonite clay powder | 5 | g |
| Naphtenic oil (low viscosity) | 5 | g |
| U.V. Absorber (HALS) | 2 | g |
| MDI based prepolymer | 10 | g |

The resulting liquid mixture is applied within a 10 minutes period to the rubber granulate, in the rotating drum and the speed of rotation is progressively reduced to avoid particle agglomeration. Rotation is however kept until tock free surface of the granulate. A dustless green granulate is obtained.

### Example 2

Cryogenic Rubber granulate (1000 g) with average granulometry between 0.8 mm and 2.4 mm was covered using the following reactive mixture:

| | | |
|---|---|---|
| PVC based Plastisol | 62 | g |
| Oleophilic, Metalless Green pigment | 5 | g |
| Ammonium Polyphosphate (powder) | 13 | g |
| Montemovillonite clay powder | 5 | g |
| Naphtenic oil (low viscosity) | 5 | g |
| U.V. Absorber (HALS) | 2 | g |
| MDI based prepolymer | 8 | g |

The resulting liquid mixture is applied within a 12 minutes period to the rubber granulate, in the rotating drum, and the speed of rotation in progressively reduced to avoid particle agglomeration.

Hot air is then blowed in the rotating drum until the covered rubber particles are tack free.

A dustless green granulate is obtained.

### Example 3

Covered rubber granulates obtained in example 1 and 2 were tested comparatively to the non-covered rubber granulate.

Several improvements were observed as follows:

Improved abrasion resistance;
Improved flame retardancy (self-extinguishable);
Leachates with reduce zinc and TOC content.

### Example 4

Covered rubber granulates obtained in example 1 and 2 were tested comparatively with single layer PVC covered green granulate.

Several technical advantages were identified in the compative tests:

Better abrasion resistance;
Much better flame retardancy;
Better resistance to U.V. and ozone.

1. A process for covering rubber particles with a continuous functional layer of polymeric nature, characterized by the use of a rotating drum with variable speed drive allowing for a progressive reduction of the speed and a pre-blend of a setting and filmifiable reactive fluid comprising a liquid resin selected from alkyd resins, polyvinyl chloride resin, urethane alkyd resins, polyurethane-urea resins and reactive polyester resins.

2. A process according to claim 1 in which the rubber particles to be covered have average dimensions from 0.1 mm average radius to 5 mm average radius.

3. A process according to claim 2 in which the rubber particles to be covered have average dimensions from 0.5 mm average radius to 2.5 mm average radius.

4. A process according to claim 1 in which the pre-blend used for coverage comprises additionally one drying component with cross linking action.

5. A process according to claim 4 in which the cross linking component is selected from poly functional isocyanates, hydrophobic ketene dimmers, isocyanate quasi-prepolymers and polyacrylchlorides.

6. A process according to claim 1 in which the pre-blend used for coverage comprises additionally an oleophilic organic pigment, a flame retardant, a flexibilizer oleophilic oil and an ultra violet radiation protector.

7. Covered rubber granulates, obtained by the process of claim 1, which comprise rubber granulates covered with a pre-blend of a setting and filmifiable reactive fluid comprising a liquid resin selected from alkyd resins, polyvinyl chloride resin, urethane alkyd resins, polyurethane-urea resins and reactive polyester resins.

8. Covered rubber granulates according to claim 7 in which the formed film layer has a thickness over 30 micron in order to be a very effective barrier to polyaromatic oils, zinc, and other mobile components of the rubber granulate.

9. Covered rubber granulates according to claim 8 in which the formed film layer has a thickness over 50 micron.

10. Covered rubber granulates according to claim 7 in which the covering film has high adherence and similar flexibility to the rubber, improving the abrasion resistance of granulate.

11. Covered rubber granulates according to claim 7 in which the colored layer does not suffer significant color change under exposure to ultraviolet radiation.

12. Covered rubber granulates according to claim 7 in which the final covered particles present improved sphericity and shape regularity due to liquid surface tension before setting and virtually dustless due to small particles and powder aggregation in the wet film.
